(19) United States
(12) Patent Application Publication
(10) Pub. No.: US 2007/0153752 A1
(43) Pub. Date: Jul. 5, 2007

(54) Method and apparatus for provisioning contacts for PTT over cellular (PoC) communication

(76) Inventor: Kevin G. Donnellan, North Brunswick, NJ (US)

Correspondence Address: INGRASSIA FISHER & LORENZ, P.C., 7150 E. CAMELBACK, STE. 325, SCOTTSDALE, AZ, 85251, US

(21) Appl. No.: 11/323,570

(22) Filed: Dec. 29, 2005

(51) Int. Cl. H04Q 7/24

(52) U.S. Cl. 370/338; 370/401

(57) ABSTRACT

A push to talk (PTT) over cellular (PoC) wireless communication system (300) includes a media server (318), a push to commute (PTC) server (310) and a subscription database (328). The media server (318) identifies a contact having a uniform resource identifier (URI), the contact identifying location informative media. The PTC server (310) is coupled to the media server (318) and includes a contact/node database (316) for receiving and storing the contact therein linked to a location corresponding to the location informative media of the contact and a contact provisioner (320) for creating a plurality of nodes for the contact, the plurality of nodes associated with the contact and including XML data management information for each of a name, a URI, a contact type, a media type, and a URI of the PTC server (310) wherein the contact is stored. The subscription database (328) receives the contact and the associated plurality of nodes from the contact provisioner (320) and stores them therein, enabling calls to be made to the contact.

### FIELD OF THE INVENTION

The present invention generally relates to PTT over Cellular (PoC) communication systems, and more particularly relates to a method and apparatus in a PoC system for provisioning contacts.

### BACKGROUND OF THE INVENTION

Today's wireless communication systems, such as cellular telephone communication systems, have a multitude of functions in addition to the traditional point-to-point audio communications. Push to Talk (PTT) is a function in a cellular phone where a specific PTT button is provided for a user to access certain cellular phone functions with a single keypress. PTT over cellular (PoC) communications is a standards-based communication protocol managed by the Open Mobile Alliance (OMA) which defines such cellular communications. Cellular communication systems also transmit multimedia signals, such as photos or videos, with or without accompanying audio and, in addition, allow cellular phone access to internet sites and information therein. While cellular phones can access the internet, surfing the internet (i.e., navigating between numerous sites on the internet) difficult. In addition, in PoC communication systems where cellular phone user operation is reduced to a single button, surfing the internet becomes quite impractical. A user could spend a lot of time on the cellular phone identifying internet contacts (i.e., internet sites of interest) without setting up and maintaining (i.e., provisioning) the contacts in a meaningful manner to allow later access to the provisioned contacts.

Thus, what is needed is a method and apparatus for provisioning contacts to allow access thereto by PoC communications. Furthermore, other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and

FIG. 1 is a block diagram of a wireless communication system in accordance with an embodiment of the present invention;

FIG. 2 is a block diagram of a wireless communication device of the communication system of FIG. 1 in accordance with the embodiment of the present invention;

FIG. 3 is a diagram of the Push to Commute (PTC) system incorporating the communication system of FIG. 1 and the wireless communication device of FIG. 2 in accordance with the embodiment of the present invention;

FIG. 4 is a flow diagram of a contact provisioning operation of the PTC system of FIG. 3 in accordance with the embodiment of the present invention;

FIG. 5 is a flow diagram of an operation for choosing contacts in the PTC system of FIG. 3 in accordance with the embodiment of the present invention; and

FIG. 6 is a flow diagram for a server provisioning operation in the PTC system of FIG. 3 in accordance with the embodiment of the present invention; and

FIG. 7 is a flow diagram for distributed PTC server operation in the PTC system of FIG. 3 in accordance with the embodiment of the present invention.

### DETAILED DESCRIPTION OF THE INVENTION

In a push to talk (PTT) over cellular (PoC) wireless communication system having a push to commute (PTC) server, a method for provisioning a contact is provided. The contact identifies location informative media. A contact having a uniform resource identifier (URI) is identified and stored in a contact/node database linked to a location corresponding to the location informative media of the contact. A plurality of nodes for the contact are created, the plurality of nodes associated with the contact and including XML data management information for each of a name, a URI, a contact type, a media type, and a URI of the PTC server wherein the contact is stored. The contact and the associated plurality of nodes are then stored in a subscription database, allowing calls to be made to the contact.

A push to talk (PTT) over cellular (PoC) wireless communication system includes a media server, a push to commute (PTC) server and a subscription database. The media server identifies a contact having a uniform resource identifier (URI), the contact identifying location informative media. The push to commute (PTC) server is coupled to the media server and includes a contact/node database for receiving and storing the contact therein linked to a location corresponding to the location informative media of the contact and a contact provisioner for creating a plurality of nodes for the contact, the plurality of nodes associated with the contact and including XML data management information for each of a name, a URI, a contact type, a media type, and a URI of the PTC server wherein the contact is stored. The subscription database receives the contact and the associated plurality of nodes from the contact provisioner and stores them therein, enabling calls to be made to the contact.

A method for distributed transcoding of multimedia information in a wireless communication system includes retrieving the multimedia information and a method of transcoding associated therewith and transcoding the multimedia information in accordance with the stored method of transcoding by a personal computer (PC) coupled to the wireless communication system.

The following detailed description of the invention is merely exemplary in nature and is not intended to limit the invention or the application and uses of the invention. Furthermore, there is no intention to be bound by any theory presented in the preceding background of the invention or the following detailed description of the invention.

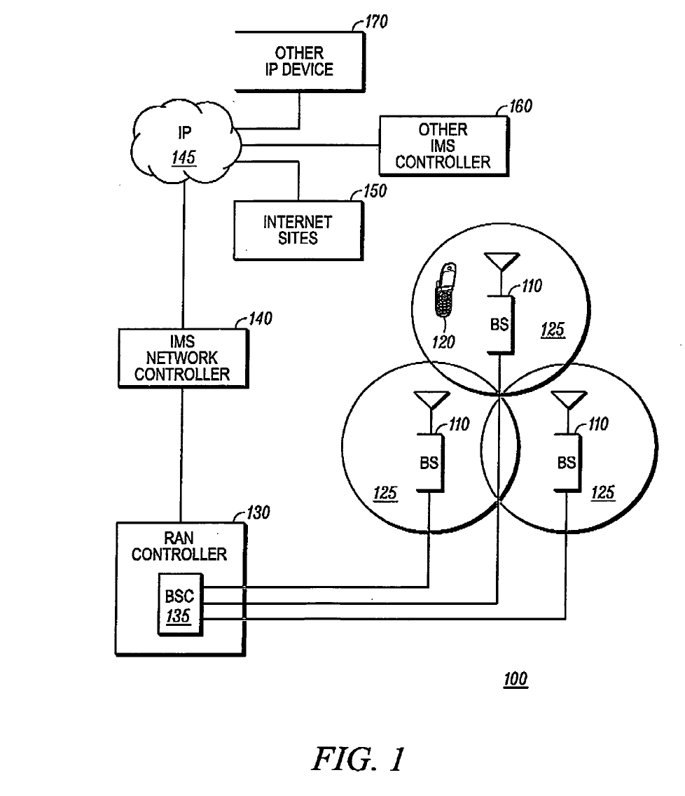

Referring to FIG. 1, a wireless communication system 100 in accordance with an embodiment of the present invention includes a plurality of base stations 110 and a wireless communication device 120. The plurality of base stations 100 communicate with the wireless communication device 120 via radio frequency (RF) signals. Associated with each of the plurality of base stations 110 is a coverage area or cell 125 wherein the wireless communication device 120 can receive signals from and transmit signals to such one of the plurality of base stations 110.

The plurality of base stations 110 are coupled to a radio access network controller 130 for control of communications in the wireless communication system 100. In particular, the plurality of base stations 110 are coupled to a base station controller 135 of the radio access network controller 130 which controls signaling with each of the plurality of base stations 110. The radio access network controller 130 can access the base station controller 135 to determine which cell 125 of the wireless communication system 100 a wireless communication device 120 is located in by determining which one of the plurality of base stations 110 is receiving RF signals from the wireless communication device.

The radio access network controller 130 is coupled to an internet protocol (IP) multimedia subsystem (IMS) network controller 140. The IMS network controller 140 is an internet server for control of IMS communications between the radio access network and the internet 145. For example, the wireless communication device 120 could access an internet site 150 through the IMS network controller 140. In addition, the IMS controller 140 could establish and maintain communications with another IMS communication system by coupling to another IMS controller 160 or could couple to any of a number of other IP devices 170 for establishing and maintaining an IMS communication session.

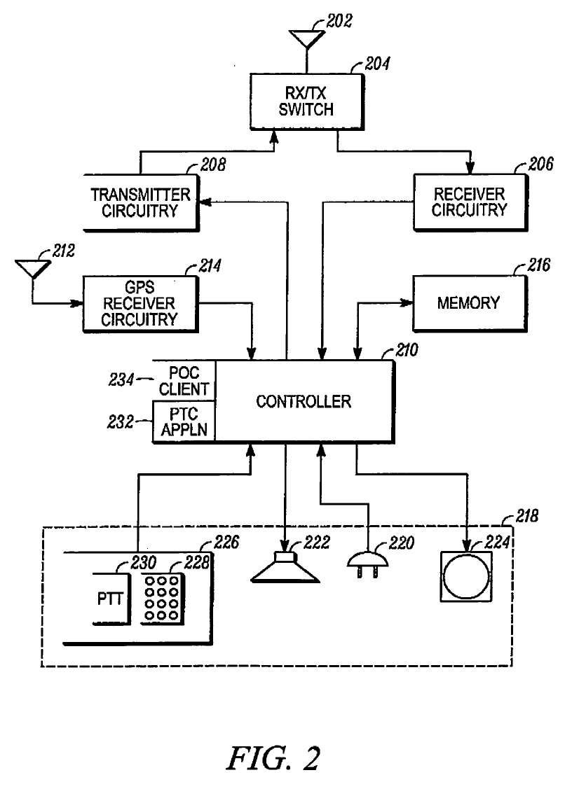

Referring to FIG. 2, a wireless communication device 120 in accordance with the embodiment of the present invention is shown. The wireless communication device 120 includes an antenna 202 for receiving and transmitting radio frequency (RF) signals. A receive/transmit switch 204 selectively couples the antenna 202 to first receiver circuitry 206 and transmitter circuitry 208 in a manner familiar to those skilled in the art. The first receiver circuitry 206 demodulates and decodes the RF signals received from the base stations 110 (FIG. 1) to derive information therefrom and is coupled to a controller 210 for providing the decoded information thereto for utilization thereby in accordance with the function(s) of the wireless communication device 120. The controller 210 also provides information to the transmitter circuitry 208 for encoding and modulating information into RF signals for transmission from the antenna 202.

A second antenna 212 is coupled to second receiver circuitry 214 for receiving, demodulating and decoding Global Positioning System (GPS) signals received from satellites of a GPS system to extract location information therefrom indicating the location of the wireless communication device 120. As is well-known in the art, the controller 210 is typically coupled to a memory device 216 and a user interface 218 to perform the functions of the wireless communication device 120.

The user interface 218 includes a microphone 220, a speaker 222 and a display 224 which may be designed to accept touch screen inputs. The user interface 218 also includes one or more key inputs 226, including a keypad 228 and a push-to-talk (PTT) button 230. The PTT button 230 is given a form factor, such as designed taller than the other key inputs 226, so that a user can easily access the PTT button 230. As to functionality, the PTT button 230 provides the user a single keypress to initiate a predetermined application or function of the wireless communication device 120. In accordance with the present invention, a Push-to-Commute (PTC) application 232, stored in the controller 210, operates under the control of the PTT button 230.

The wireless communication device 120 can communicate with other wireless communication devices 120 in the radio access network managed by the radio access network controller 130. In addition, the wireless communication device 120 is an IMS-enabled wireless communication device 120 and can participate in multimedia IP communication sessions, such as IMS communication sessions, via the IMS network controller 140 (FIG. 1). One such IMS communication session is a PTT over cellular (PoC) communication session. The wireless communication device 120 can initiate or join PoC communication sessions through activation of a PoC client application 234 in the controller 210.

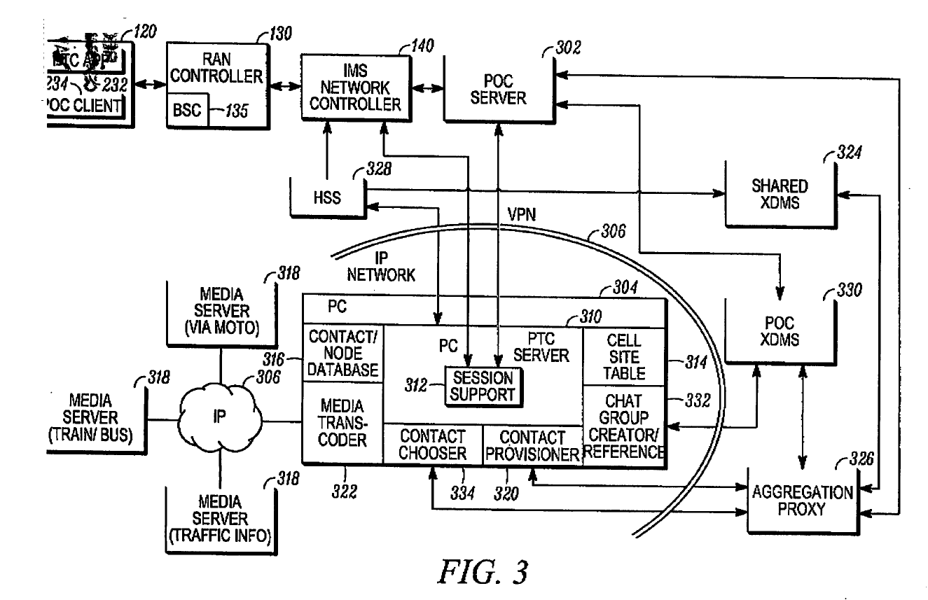

Referring next to FIG. 3, a push to commute (PTC) system 300 in accordance with an embodiment of the present invention permits a user of an IMS-enabled wireless communication device 120, such as a cellular telephone, to timely access commute-related up-to-date transportation information with use of the PTT button 226. In essence, the PTC system 300 functions as an up-to-date transportation notification system, advising the user of present traffic conditions (e.g., road conditions, traffic density) on his commute route or commuting schedules of public transportation (e.g. bus schedules, train schedules, bus or train delays).

PoC communications allow a user to initiate or join PoC communication sessions in accordance with PoC standards formulated by the Open Mobile Alliance (OMA) for internet protocol (IP) communication sessions. The PTC system 300 is a PoC-based system, utilizing the pre-defined features and characteristics of PoC communications and providing a PoC server 302 coupled to the IMS network controller 140 for managing the PoC communications.

In accordance with the present invention, a personal computer (PC) 304 is coupled to the PoC server 302 and the IMS network controller 140 across an IP network 306 by a virtual private network (VPN) connection 308. The VPN connection 308 is a secure connection provided across the IP network 306 to allow the PC 304 to communicate with the IMS network controller 140 and the PoC server 302 to establish, join or maintain PTC communication sessions. In addition to conventional PC functions, the PC 304 includes PTC-specific applications to function as a PTC server 310 by, for example, providing session support 312 for the PTC communication sessions. In addition, the PC 304 maintains a cell site table 314 for the cells/base stations 110 of the wireless communication system 100 for defining a geographic location in response to receiving cell site identification information identifying a cell 110 that is receiving and transmitting signals to the wireless communication device 120.

The PC 304 also maintains a contact/node database 316 having one or more contacts stored therein along with a plurality of nodes for each contact. In accordance with the present invention, a contact is data identifying location informative media accessible at one of a plurality of media servers 318 accessible through the IP network 306. For example, a contact could identify video media (up-to-date photos or video feed) from a highway camera that is accessed over the IP network 306 by a server 318, such as a public highway department website server. Also, a contact could identify information such as bus or train schedules and up-to-date delays or schedule changes that is provided over the IP network 306 by a server 318, such as a public transportation company's website server. In addition, a contact could identify information such as location specific traffic information that can be accessed over the IP network 306 by a server 318 such as a ViaMoto server.

Prior to a contact being stored in the contact/node database 316, the contact is provisioned by a contact provisioner 320 which creates the plurality of nodes for the contact. In accordance with the embodiment of the present invention, the plurality of nodes would include a name for the contact, a uniform resource identifier (URI) assigned to a uniform resource locator (URL) of the location informative media, a contact type, a media type, a URI of the PTC server 310, and a method for transcoding the location informative media when it is accessed by the PTC server 310. The plurality of nodes are stored with a contact in XML format as XML data management information for the contact.

Transcoding the media refers to the process of changing the coding of the media received from a media server 318 to a coding by the wireless communication device 120 in a PTC communication system. For example, transcoding could include scaling the media, converting the codec of the media (such as converting BMP visual media to JPG visual media), or changing the extension name of the media (such as changing the extension from .jpeg to .jpg). When accessing a contact, a media transcoder 322 transcodes the location informative media of the contact in accordance with a method of transcoding stored as one of the nodes of the contact. The present invention supports distributed computed transcoding by providing the media transcoder 322 in the PC 304 instead of centrally supplied, such as in the PoC server 302. The media is thus advantageously transcoded by the media transcoder 322 before being provided to the PTC server 310, providing more efficient and speedy processing of the media to provide it in a timely manner to the wireless communication device 120.

The contact provisioner 320 is coupled to a shared XML data management server (shared XDMS) 324 via an aggregation proxy 326. When a contact is going to be added to the contact/node database 316, the contact provisioner 320 contacts the aggregation proxy 326 which authenticates the information from the contact provisioner and determines if the shared XDMS 324 is the intended server for the new contact information. If the XDMS 324 is the intended recipient, the XDMS 324 verifies whether the contact is a new contact. New contacts are stored in a subscription database in a home subscriber server (HSS) 328, the HSS 328 coupled to the IMS network controller 140 and the PoC server 302 for IMS operation and for, in accordance with the present invention, maintaining the subscription database to enable PTC communication sessions with contacts stored therein. In addition to provisioning contacts, when contacts are chose by a contact chooser 334, a message is sent to the aggregation server 326 for authentication and forwarding to the appropriate XDMS, in this case a PoC XML data management server (PoC XDMS) 330.

The PoC XML data management server (PoC XDMS) 330 is coupled to the PoC server 302 and maintains PoC policies and functionality for the establishment and maintenance of communications in the PoC/IMS system in accordance with OMA standards. In addition, in accordance with the embodiment of the present invention, a chat group creator/reference 332 communicates with the PoC XDMS 330 via the aggregation proxy 326 to create and maintain a database of chat groups and group call information at the PoC XDMS 330 for establishing location-based chat groups to allow commuters to exchange current information on traffic conditions or public transportation schedules. Participation in location-based chat groups is referred to as operation of the PTC system in the CB radio mode.

Thus it can be seen that the embodiment of the present invention provides a system for PTC communications where a user of a PTC-enabled wireless communication device 120 can receive up-to-date transportation information and notification of commute conditions information through accessing location informative media at a plurality of contacts or joining location-based chat groups. Hereinafter, functioning of the PTC system 300 will be described in reference to flow diagrams showing various operations of the PTC system 300 in accordance with the embodiment of the present invention.

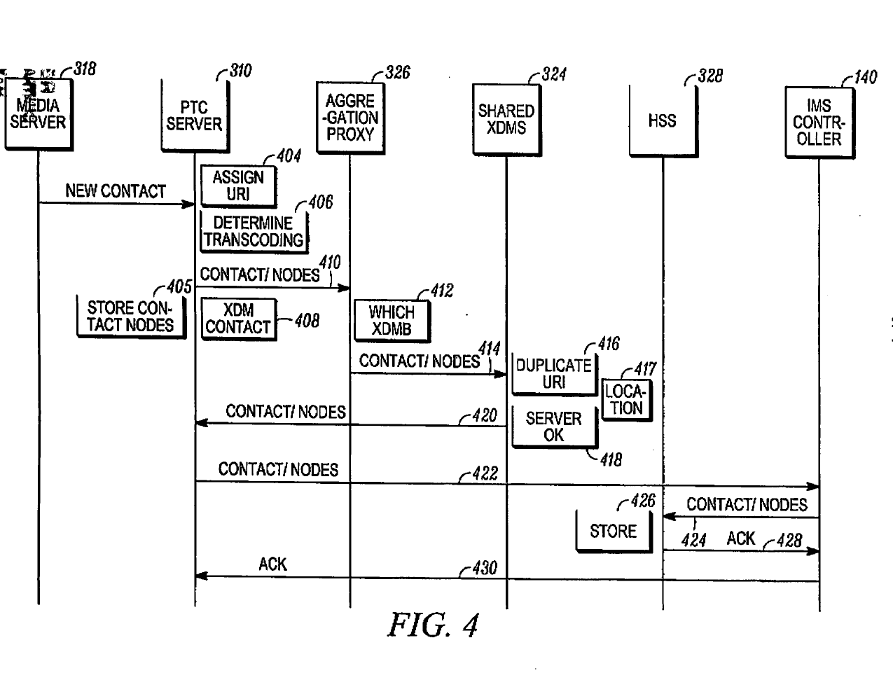

A flow diagram of the process for provisioning contacts in accordance with the embodiment of the present invention is depicted in FIG. 4 which includes operations of the media server 318, the PTC server 310, the aggregation proxy 326, the shared XDMS 324, the IMS controller 140 and the HSS 328.

Initially, the PTC server 310 receives a document 402 from the media server 318. The media server 318 could be a server with traffic cams, a server with train/bus status updates, a server with train/bus schedules, a ViaMoto server with location specific traffic information, or some other server with traffic media. The document received from the media server 318 contains a list of media elements that will be converted to PoC contacts. Each media element contains a name, a media type including attributes (e.g., JPG images of size VGA), and the URL for the media. The PTC server 310 assigns a URI to the URL of the media 404 and creates a record in the PTC contact/node database 316 linked to the assigned URI 405. The PTC server 310 also determines the method of transcoding the media (e.g., scaling, converting the codec, or just changing extension to name) 406.

The PTC server 310 then creates XDM contacts for each node 408. The nodes (XDM contacts) contain the name, URI, contact type, media type, and URI of the PTC Server 310 (as the location server for this contact). A request to add contact is sent 410 to the aggregation proxy 326. The aggregation proxy 326 determines whether the shared XDMS 324 should be the recipient of the request 412. If the shared XDMS 324 is the intended recipient, the aggregation proxy 326 forwards the request 414 thereto. The shared XDMS 324 checks the URI of the contact and makes sure it is not a duplicate 416 in accordance with OMA PoC standard requirements. The shared XDMS 324 will accept the new fields (i.e., contact type, media type, and URI of location server) 417 and will check the URI of the location server to determine if it is already a contact 418. The shared XDMS 324 then sends an acknowledgement 420 to the PTC server 310.

The PTC server 310 next adds the new contacts to a subscription database of the HSS 328 by forwarding the new contact and its associated nodes 422 to the IMS controller 140 for forwarding the contacts on 424 to the HSS 328. Storing the contacts in the subscription database 426 allows PTC communication sessions to be established with these contacts. After storing the contacts 426, the HSS 328 forwards an acknowledgement 428 to the IMS controller 140 for providing 430 to the PTC server 310.

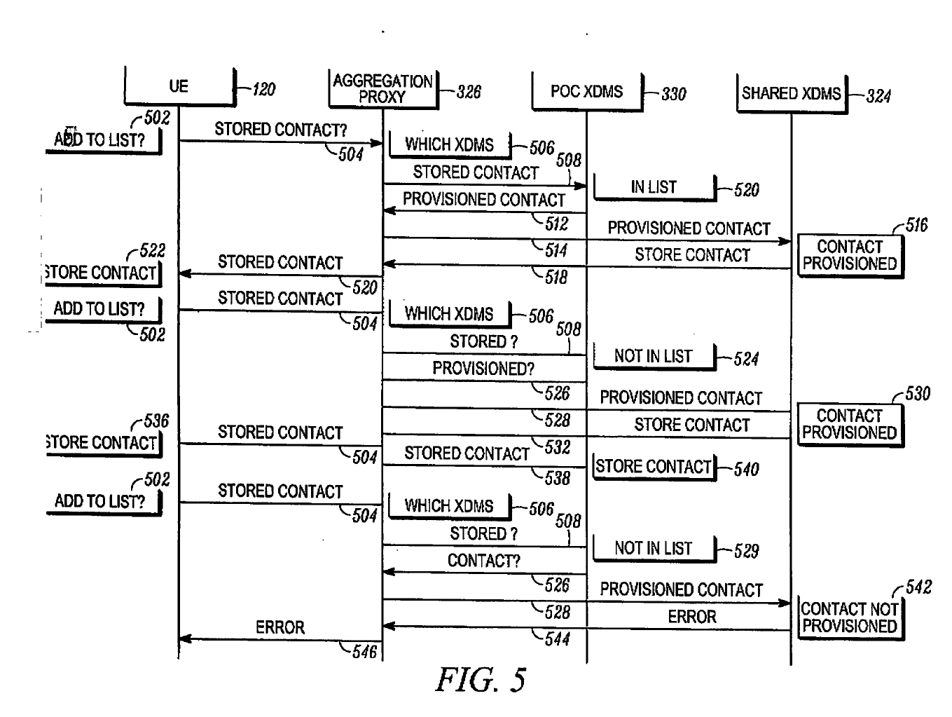

Referring next to FIG. 5, a flow diagram for choosing contacts by a user of a PTC-enabled wireless communication device 120 in accordance with an embodiment of the present invention is shown. FIG. 5 shows operation at a user entity (a PTC-enabled wireless communication device) 120, the aggregation proxy 326, the PoC XDMS 330, and the shared XDMS 324.

The PTC application 232 of the user entity 120 includes an XDM Client which controls the maintenance of a list of contacts stored in the memory 216. When a user inputs a new contact (i.e., one not listed in the currently stored contact list) 502, the new contact and associated information is then forwarded to the transmitter circuitry 208 from where the new contact is transmitted 504 to the aggregation proxy 326 for determination of which XDMS 324, 330 the request is intended for 506. The aggregation proxy 326 determines that the request is intended for the PoC XDMS 330 sends it 508. The PoC XDMS 330 checks the URI of the new contact 510 to determine if it is a duplicate of another URI stored at the PoC XDMS 330. If the contact is already stored at the PoC XDMS 330, the PoC XDMS 330 sends an appropriate message 512 to the aggregation proxy 326 for forwarding 514 to the shared XDMS 324 to determine if the contact is provisioned (i.e., is stored in the contact database of the shared XDMS 324), the message indicating that the contact is stored at the PoC XDMS 330. If the contact is not already stored in the memory 216, the controller 210 stores the contact in the contact list. When the shared XDMS 324 determines that the contact is provisioned 516, the shared XDMS sends a store contact message 518 to the aggregation proxy 326 for forwarding 520 to the user entity 120. The contact is then stored 522 in the contact list of the memory 216.

When the PoC XDMS 330 determines that the contact is not stored therein 524, a message (including the URI of the contact) is sent to the aggregation proxy 526 for forwarding 528 to the shared XDMS 324. When the shared XDMS 324 determines that the contact is provisioned 530, this information is sent 532 to the aggregation proxy 326 form where it is forwarded 534 to the user entity 120 for storage in the contact list 536 of the memory 216 and also forwarded 538 to the PoC XDMS 330 for storage 540 therein. When the contact is not provisioned 542, the shared XDMS 324 generates an error (HTTP 409) which is sent 544 to the aggregation proxy 326, which sends it 546 to the user entity 120.

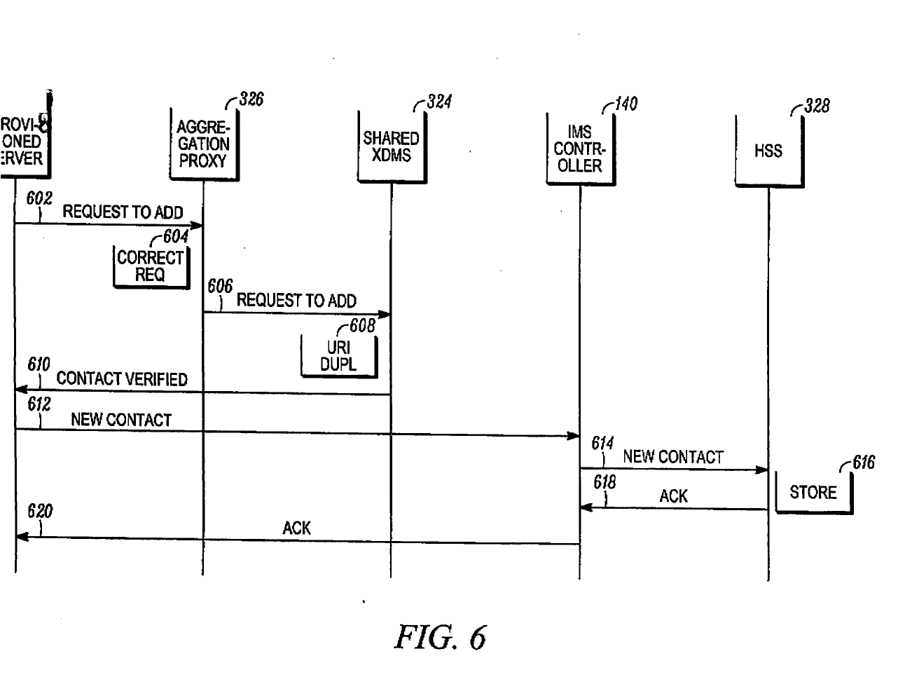

In addition to provisioning location informative media as contacts for the up-to-date transportation notification system (PTC system 300), location servers 601, such as a PTC server, can be added as contacts, thereby providing access to contacts of the provisioned server 601. Thus, contacts with contact type node information identifying a location server 601 can be provisioned. Referring to FIG. 6, a flow diagram for location server provisioning begins with a request to add the server 601 being sent 602 from the location server 601 to the aggregation proxy 326. The aggregation proxy 326 determines whether the shared XDMS 324 should be the recipient of the request 604. If the shared XDMS 324 is the intended recipient, the aggregation proxy 326 forwards the request 606 thereto. The shared XDMS 324 checks the URI of the contact (i.e., the URI of location server 601) and makes sure it is not a duplicate 608. The shared XDMS 324 will accept the new fields (i.e., contact type, media type, and URI of location server) sends an acknowledgement 610 to the location server 601.

The location server 601 next adds the new contacts to a subscription database of the HSS 328 by forwarding the new contact and its associated nodes 612 to the IMS controller 140 for forwarding the contacts on 614 to the HSS 328. Storing the contacts in the subscription database 616 allows PTC communication sessions to be established with the location server 601. After storing the contacts 616, the HSS 328 forwards an acknowledgement 618 to the IMS controller 140 for providing 620 to the location server 601.

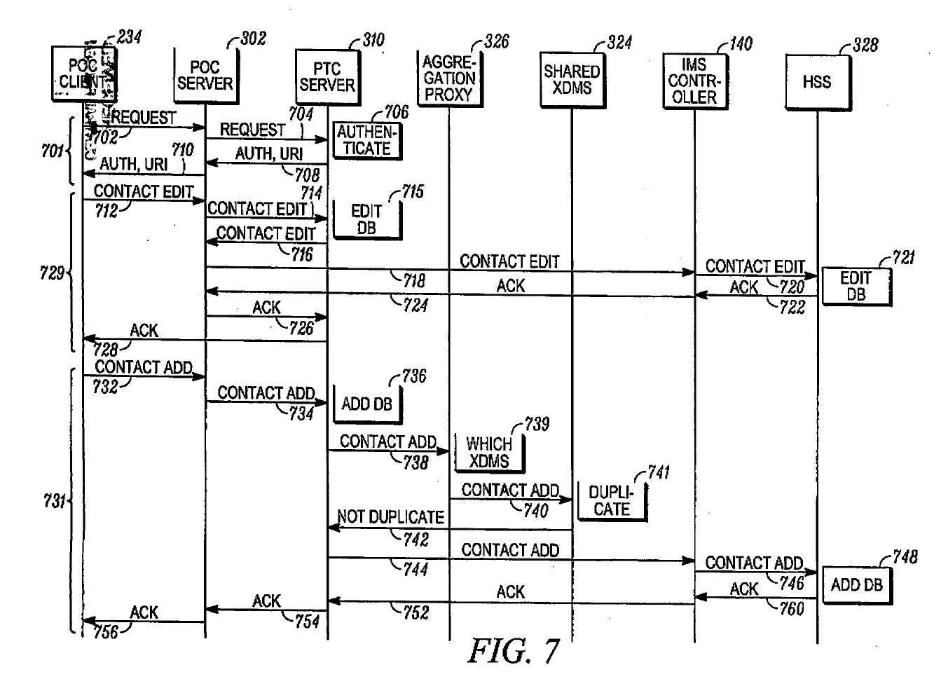

The PTC server 310 can add contacts (provision contacts) as described hereinabove. The PC 304 can be used to access the PTC server 310 operating therein to locally delete contact records in the contact/node database 316 and the subscription database in the HSS 328 or to edit node information of the contacts stored thereat. In accordance with the embodiment of the present invention, a user can also add, delete or edit contacts using the wireless communication device 120. In this manner, the present invention provides a distributed PTC server 310 whereby these contact provisioning functions of the PTC server can be remotely performed. FIG. 7 is a flow diagram of the distributed PTC server operation in reference to the PoC client 234 at the wireless communication device 120, the PoC server 302, the PTC server 310, the aggregation proxy 326, the shared XDMS 324, the IMS controller 140 and the HSS 328.

Initially, the PoC client 234 must be authenticated 701 (i.e., it must be determined that the PoC client 234 is authorized to add, edit or delete contacts of the contact/node database 316 and the subscription database of the HSS 328). When the PoC client 234 sends a request to add, edit or delete contact information 702 to the PoC server 302, the PoC server 302 forwards the request 704 to the PTC server 310. The PTC server 310 authenticates the PoC client 234 as an entity entitled to add, edit or delete contact information 706. If authorized 706, the PTC server 310 forwards authorization and a URI 708 for use by the PoC client 234 to the PoC server 302, which is then transmitted 710 to the PoC client 234. The URI allows the PoC client 234 to be temporarily recognized as a location server authorized to add, delete or edit contacts and/or nodes associated with a contact.

Using the authorized URI provided, the PoC client 234 of the user entity 120 transmits an instruction to edit or delete the contact information 712 to the PoC server 302, which provides the instruction 714 to the PTC server 310. As the PTC server recognizes that authorization has been provided, the instruction is used to delete or edit contact/node information 715 in the contact/node database 316. The PTC server 310 then forwards the instructions 716 to the PoC server 302 which forwards it 718 to the IMS controller 140 and then it is provided 720 to the HSS 328. The HSS then deletes or edit contact/node information in the subscription database 721 in accordance with the instructions received. An acknowledgement is then sent 722 from the HSS 328 to the IMS controller 140, and then forwarded 724 to the PoC server 302, and sent on 726 to the PTC server 310. The PTC server 310 then transmits the acknowledgement 728 to the PoC client 234, thereby completing the edit or delete routine 729.

After authentication 701, the PoC client 234 can alternatively choose to add contacts 731. The PoC client 234 can request to add contacts by providing location information identifying a location of the wireless communication device 120 for which the user would like to add contacts. Initially, the PoC client 234 transmits a contact add request 732 to the PoC server 302, the PTC server 310 receiving the contact add request 734 transmitted from the PoC client 234. The PTC server 310 identifies the contact and assigns a URI to the contact, then creates a record in the PTC contact/node database 316 linked to the assigned URI 736. The contact could be identified by contacting a media server 318 selected in response to the location information and determining whether any contact could provide user identified information or, if no media type or other identified information is provided, could provide commute related information related to the location identified by the location information. The request to add contact is then sent 738 to the aggregation proxy 326. The aggregation proxy 326 determines whether the shared XDMS 324 should be the recipient of the request 739. If the shared XDMS 324 is the intended recipient, the aggregation proxy 326 forwards the request thereto 740. The shared XDMS 324 checks the URI of the contact and makes sure it is not a duplicate 741 and sends an acknowledgement 742 to the PTC server 310. The PTC server 310 adds the new contact to a subscription database of the HSS 328 by forwarding the new contact and its associated nodes 744 to the IMS controller 140 for forwarding the contacts on 746 to the HSS 328. The contacts are then stored in the subscription database 748 and the HSS 328 forwards an acknowledgement 750 to the IMS controller 140 for providing 752 to the PTC server 310. The PTC server 310 then forwards the acknowledgement 754 to the PoC server 302 for transmission 756 to the PoC client 234 so that the user requesting the addition is aware that it has been made.

In addition to the distributed PTC server 310 operation described in reference to FIG. 7, the PTC server may implement other efficiencies for an improved PTC communication system 300. For example, the PTC server 310 may have an automatic method for provisioning certain types of media from general web sites as long as the URL is provided. An automatic algorithm would identify the type of media and determine the transcoding method. Alternatively, standard media servers 318 (eg. Traffic camera servers) could be provisioned in the PTC server 310 ahead of time. Any updates to media element lists could allow provisioning of new elements.

Thus it can be seen that the present invention provides a method and an apparatus for provisioning contacts by a user from his wireless communication device 120 or in response to location informative media from a media server 318. The provisioned contacts are stored in a contact list in the memory 216 of the wireless communication device 120, the contact/node database 316 of the PTC server 310 and a subscription database of the home subscriber server (HSS) 328 to enable establishment and maintenance of PoC communication sessions, or more specifically, Push to Commute (PTC) communication sessions providing current transportation information and up-to-date notifications helpful to a commuter.

While at least one exemplary embodiment has been presented in the foregoing detailed description of the invention, it should be appreciated that a vast number of variations exist. For example, the method and apparatus disclosed herein relates to an embodiment of the present invention in a Push to Commute (PTC) communication system 300. However, the present invention is not limited to PTC communication systems 300; the present invention could be utilized to provide a speedier and more efficient internet surfing mechanisms for cellular phone users in an IMS-enabled wireless communication system. The transcoding features of the present invention allow distributed transcoding using a server coupled to an IMS-enabled wireless communication system, thereby providing more efficient access to multimedia data such as streaming video or photos. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

What is claimed is:

1. A method for provisioning a contact in a push to talk (PTT) over cellular (PoC) wireless communication system having a push to commute (PTC) server, the contact identifying location informative media, the method comprising the steps of:
identifying a contact having a uniform resource identifier (URI);
storing the contact in a contact/node database linked to a location corresponding to the location informative media of the contact;
creating a plurality of nodes for the contact, the plurality of nodes associated with a contact and including XML data management information for each of a name, a URI, a contact type, a media type, and a URI of the PTC server wherein the contact is stored; and
storing the contact in a subscription database, thereby allowing calls to be made to the contact.

2. The method of claim 1 wherein the step of identifying a contact having a uniform resource identifier (URI) comprises the step of assigning a URI to a uniform resource locator (URL) of the location informative media of the contact, wherein the step of storing the contact in the contact/node database comprises the step of storing the URI in a record of the contact/node database linked to the location corresponding thereto.

3. The method of claim 1 further comprising the step of determining a method of transcoding the location informative media of the contact, wherein the plurality of nodes associated with the contact include the method of transcoding the contact.

4. The method of claim 3 wherein the step of determining a method of transcoding comprises the step of determining a method of PTC server transcoding, wherein PTC server transcoding is transcoding of the location informative media of the contact by the PTC server.

5. The method of claim 4 wherein the PTC server is a personal computer (PC) and wherein the step of determining a method of PTC server transcoding comprises the step of determining a method of distributed computed transcoding for transcoding the location informative media of the contact by the PC.

6. The method of claim 1 further including the steps of:
sending a request to add message to a shared XML data management server (XDMS), the request to add message including contact information identifying the contact and the plurality of nodes associated with the contact;
determining whether the contact identified by the request to add message is already stored as a contact; and
determining whether a location server of the contact is already stored in response to the plurality of nodes, and
wherein the step of storing the contact in a subscription database comprises the step of storing the contact in a subscription database in response to determining that the contact identified by the request to add message is not already stored as a contact and determining that a location server of the contact is not already stored.

7. The method of claim 6 further comprising the steps of:
sending a request to add message to an aggregation proxy; and
determining if the shared XDMS is an intended recipient of the request to add message, and
wherein the step of sending a request to add message to the shared XDMS comprises the step of forwarding the request to add message from the aggregation proxy to the shared XDMS in response to determining that the shared XDMS is the intended recipient.

8. The method of claim 7 further comprising the steps of:
the PTC server receiving a document from the media server containing a list of media elements that will be converted to PoC contacts; each of the media elements containing a name, a media type and attributes associated therewith and a URL of the media element; and
the PTC server creating a record in the contact/node database for each of the media elements, the PTC server linking each record to the URL of the corresponding media element.

9. The method of claim 8 wherein a PoC XDMS associates one contact URI identifying the PTC server with plurality of contacts, the plurality of contacts being the contacts stored in the contact/node database of the PTC server.

10. The method of claim 1 further comprising the steps of:
the PTC server receiving a list of media elements that will be converted to PoC contacts from a user; each of the media elements containing a name, a media type and attributes associated therewith and a URL of the media element; and
the PTC server creating a record in the contact/node database for each of the media elements, the PTC server linking each record to the URL of the corresponding media element.

11. The method of claim 1 wherein the PTC server provides a contact subscription service to accept contact subscriptions from provisioned PTC Servers, the contact subscriptions identifying contacts having the contact type associated therewith being a location server.

12. The method of claim 1 wherein the step of storing the contact in a subscription database comprises the step of storing the subscription database in the PTC server.

13. A push to talk (PTT) over cellular (PoC) wireless communication system comprising:
a media server identifying a contact having a uniform resource identifier (URI), the contact identifying location informative media; and
a push to commute (PTC) server coupled to the media server; the PTC server comprising:
a contact/node database coupled to the media server for receiving and storing the contact therein linked to a location corresponding to the location informative media of the contact; and
a contact provisioner coupled to the contact/node database and creating a plurality of nodes for the contact, the plurality of nodes associated with a contact and including XML data management information for each of a name, a URI, a contact type, a media type, and a URI of the PTC server wherein the contact is stored; and
a subscription database coupled to the contact provisioner for storing the contacts and the plurality of nodes associated therewith, enabling calls to be made to the contact.

14. The PoC wireless communication system of claim 13 wherein the contact provisioner assigns a uniform resource locator (URL) to the URI of the location informative media of the contact, and wherein the contact/node database stores the URL in a record thereof linked to the location corresponding thereto.

15. The PoC wireless communication system of claim 13 wherein the PTC server further comprises a media transcoder coupled to the media server and determining a method of transcoding the location informative media of the contact, wherein the plurality of nodes associated with the contact include the method of transcoding the contact.

16. The PoC wireless communication system of claim 15 wherein the PTC server is a personal computer (PC) and wherein the media transcoder determines a method of distributed computed transcoding for transcoding the location informative media of the contact by the PC.

17. The PoC wireless communication system of claim 13 further comprising a shared XML data management server (XDMS) coupled to the contact provisioner for receiving a request to add message therefrom, the request to add message including contact information identifying the contact and the plurality of nodes associated with the contact, the shared XDMS determining (a) whether the contact identified by the request to add message is already stored as a contact and (b) determining, in response to the plurality of nodes, whether a location server of the contact is already stored, and wherein the shared XDMS stores the contact in the subscription database of the PTC server in response to determining that the contact identified by the request to add message is not already stored as a contact and determining that a location server of the contact is not already stored.

18. The PoC wireless communication system of claim 17 further comprising an aggregation proxy coupled to the contact provisioner and the shared XDMS, the aggregation proxy receiving the request to add message, determining if the shared XDMS is an intended recipient of the request to add message, and forwarding the request to add message to the shared XDMS in response to determining that the shared XDMS is the intended recipient.

19. The PoC wireless communication system of claim 18 wherein the PTC server receives a document from the media server containing a list of media elements that will be converted to PoC contacts; each of the media elements containing a name, a media type and attributes associated therewith and a URL of the media element, creating a record in the contact/node database for each of the media elements and linking each record to the URI of the corresponding media element.

20. The PoC wireless communication system of claim 19 further comprising a PoC XDMS coupled to the PTC server for associating one contact URI identifying the PTC server with a plurality of contacts, the plurality of contacts being the contacts stored in the contact/node database.

21. The PoC wireless communication system of claim 13 further comprising a user input device coupled to the PTC server, the PTC server receiving a list of media elements that will be converted to PoC contacts from the user input device, each of the media elements containing a name, a media type and attributes associated therewith and a URL of the media element and creating a record in the contact/node database for each of the media elements, linking each record to the URI of the corresponding media element.

22. The PoC wireless communication system of claim 13 wherein the PTC server provides a contact subscription service to accept contact subscriptions from provisioned PTC Servers, the contact subscriptions identifying contacts having the contact type associated therewith being a location server.

23. The PoC wireless communication system of claim 22 wherein the PTC server stores accepted contact subscriptions in the subscription database thereof.

24. A method for transcoding a contact in a push to talk (PTT) over cellular (PoC) wireless communication system having a push to commute (PTC) server, the contact having a uniform resource identifier (URI) associated therewith and identifying location informative media, the method comprising the steps of:
retrieving a contact and a plurality of nodes associated therewith from a contact/node database in response to the location informative media of the contact, the plurality of nodes comprising XML data management information for each of a name, the URI associated with the contact, a contact type, a media type, a method of transcoding the location informative media of the contact, and a URI of the PTC server wherein the contact is stored; and
the PTC server transcoding the location informative media of the contact in accordance with the method of transcoding of the plurality of nodes of the contact.

25. The method of claim 24 wherein the PTC server is a personal computer (PC) and wherein the step of transcoding comprises the step of distributed computed transcoding for transcoding the location informative media of the contact by the PC.

26. A push to talk (PTT) over cellular (PoC) wireless communication system comprising:
a media server identifying a contact having a uniform resource identifier (URI), the contact identifying location informative media; and
a push to commute (PTC) server coupled to the media server; the PTC server comprising:
a media transcoder coupled to the media server for transcoding the location informative media of the contact;
a contact/node database coupled to the media server for receiving and storing the contact therein linked to a location corresponding to the location informative media of the contact;
a contact provisioner coupled to the contact/node database and creating a plurality of nodes for the contact, the plurality of nodes associated with a contact and including XML data management information for each of a name, a URI, a contact type, a media type, a method of transcoding the location informative media of the contact by the media transcoder, and a URI of the PTC server wherein the contact is stored; and
a subscription database coupled to the contact provisioner for storing the contacts and the plurality of nodes associated therewith, enabling calls to be made to the contact.

27. The PoC wireless communication system of claim 26 wherein the PTC server is a personal computer (PC) and wherein the media transcoder of the PC distributed computed transcodes the location informative media of the contact.
